(19) United States
(12) Patent Application Publication
(10) Pub. No.: US 2017/0237097 A1
(43) Pub. Date: Aug. 17, 2017

(54) FUEL SOURCE FOR ELECTROCHEMICAL FUEL CELL POWER SUPPLY

(71) Applicant: Intelligent Energy Limited, Loughborough (GB)

(72) Inventors: Daniel Ninan, Loughborough (GB); Zachary Elliott, Loughborough (GB); Paul Leonard Adcock, Loughborough (GB)

(73) Assignee: Intelligent Energy Limited, Loughborough (GB)

(21) Appl. No.: 15/519,405

(22) PCT Filed: Oct. 14, 2015
(86) PCT No.: PCT/GB2015/053043

§ 371 Date: Apr. 14, 2017

(30) Foreign Application Priority Data
Oct. 15, 2014 (GB) 1418302.4

(51) Int. Cl. H01M 8/065; H01M 8/04082; G06F 1/16

(52) U.S. Cl. CPC H01M 8/065; G06F 1/1635; G06F 1/1681; G06F 1/1632; H01M 8/04201; G06F 2200/202; H01M 2250/30

(57) ABSTRACT

A protective cover (10) for a portable computing device (1) provides a fuel source (14) disposed within a compartment in the protective cover. The fuel source may be a hydrogen fuel source suitable for delivering hydrogen to a fuel cell (15) within the protective cover or within the portable computing device, for generating electrical power for use by the portable computing device. The protective cover may have a plurality of planar panels (11) separated by a one or more hinge regions (12) which can each house a fuel source compartment. The protective cover may also be serviceable as a stand.

The present invention relates to fuel sources suitable for providing a fluid fuel supply to a fuel cell, e.g. an electrochemical fuel cell configured to generate electrical energy from the fluid fuel.

Portable personal computing, data processing and/or telecommunications devices are known to have significant limitations in the duration of their battery life. In this patent specification, the expression “portable computing device” is intended to encompass all such data processing devices including lap-tops, netbooks, palm computers, tablet computers, personal organisers, ‘smart phones’ and the like.

Significant efforts have been made in recent years to extend the period for which these battery-powered, portable computing devices can operate independently of a mains power supply. Typically, extending the period of independence from a mains power supply requires improvements in battery technology, increased battery size or substitute battery packs. Each of these solutions can increase cost, weight and/or size of the equipment to be carried and thereby increase inconvenience to the user. In addition, there are still significant limitations in the energy density achievable with battery power.

More recently, fuel cells have been recognised as a potential alternative portable power supply for portable computing devices. However, integration of fuel cell power technology into portable computer devices themselves may not always be convenient, and also requires the provision of two component parts of the alternative power solution, namely a fuel cell for converting a fluid fuel such as hydrogen into electrical power, and a fluid fuel supply such as a hydrogen storage tank or a reaction chamber capable of generating hydrogen on demand.

It is an object of the present invention to provide an alternative approach to powering portable computer devices by way of a fuel cell power technology.

According to one aspect, the present invention provides a protective cover for a portable computing device, comprising a fuel source disposed in a compartment within the protective cover.

The fuel source may be a hydrogen fuel source. The hydrogen fuel source may be configured to generate gaseous hydrogen by one of: a hydrolysis reaction; a thermolysis reaction; a desorption process. The protective cover may comprise a plurality of separate compartments each providing a separately actuatable fuel source. The protective cover may comprise a plurality of planar panels separated by a one or more hinge regions. The protective cover may comprise a controller. The controller may be configured to actuate release of fuel from each compartment independently. Each compartment may or may not be configured to be ruptured electrically by passing a current through a respective heating element. The controller may or may not be configured to control the individual heating elements. The protective cover may comprise a plurality of substantially planar fuel sources provided within respective planar panels that are separated by one or more hinge regions. The fuel source compartment may be substantially planar. The protective cover may include a hydrogen fluid line and hydrogen port for coupling the cover to a fuel consuming device. The cover may be moveable between a first configuration for at least partially enclosing the portable computing device and a second configuration configured to operate as a stand for the portable computing device, and the port for coupling the fluid line to the fuel consuming device may be positioned in a lower portion of the cover when in the second configuration. The protective cover may comprise a combined hydrogen port and electrical connector for coupling to a portable computing device within the protective cover. The protective cover may include a fuel cell disposed within the protective cover. The fuel source compartment may comprise a replaceable element receivable into a pouch in the protective cover.

According to another aspect, the present invention provides a power generating apparatus comprising a planar fuel cell and a planar fuel source mounted together in co-planar relationship on a common substrate. The fuel source may be a hydrogen fuel source. The hydrogen fuel source may be configured to generate gaseous hydrogen by one of: a hydrolysis reaction; a thermolysis reaction; a desorption process. The fuel source may comprise a plurality of separate compartments each providing a separately actuatable reaction chamber. The apparatus may comprise a plurality of panels separated by one or more hinge regions. The apparatus may comprise a fluid flow conduit extending across said one or more hinge regions. The power generating apparatus may comprise a controller. The controller may be configured to actuate release of fuel from each compartment independently. Each compartment may or may not be configured to be ruptured electrically by passing a current through a respective heating element. The controller may or may not be configured to control the individual heating elements.

According to another aspect, the invention provides a method of providing protection to, and power for, a portable computing device, comprising:

at least partially encasing a portable computing device with a protective cover having a fuel source disposed in a compartment within the protective cover.

The method may comprise generating fluid fuel from the fuel source and providing the fluid fuel to a fuel cell. The method may comprise providing a plurality of separate compartments each providing a separately actuatable fuel source, and actuating release of fuel from each compartment independently. The method may include connecting a fluid line from the cover to a fuel consuming device in the portable computing device. The method may include moving the cover between a first configuration for at least partially enclosing the portable computing device and a second configuration configured to operate as a stand for the portable computing device. The method may include providing a fuel cell within the protective cover and using the generated fluid fuel to generate electrical power within the fuel cell. The method may include replacing a fuel source within a compartment in the protective cover.

Embodiments of the present invention will now be described by way of example and with reference to the accompanying drawings in which:

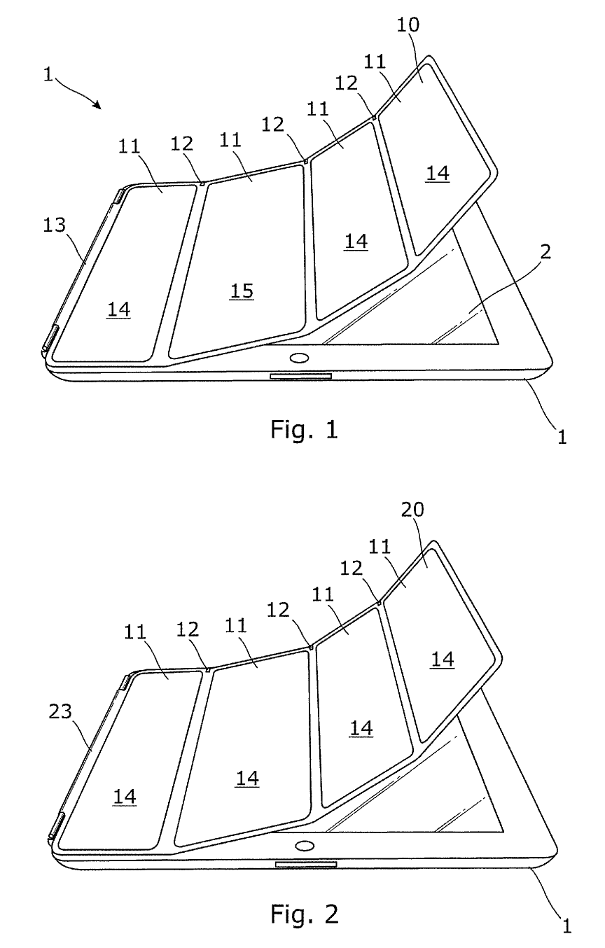

FIG. 1 shows a perspective side view of a protective cover, on a tablet computing device, incorporating a set of planar fuel sources and a planar fuel cell;

FIG. 2 shows a perspective side view of a protective cover, on a tablet computing device, incorporating a set of planar fuel sources for supplying fuel to a fuel cell embedded within the tablet computing device;

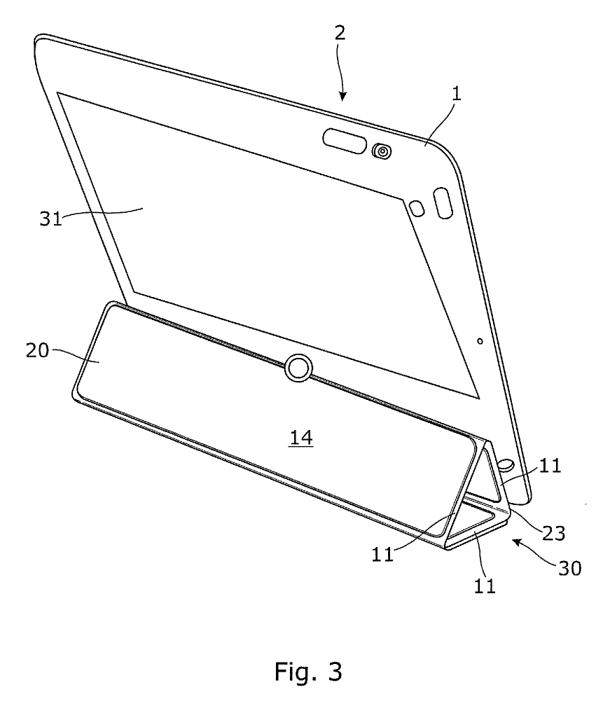

FIG. 3 shows a perspective rear view of the cover and tablet computer of FIG. 2 showing the cover in a tablet stand configuration;

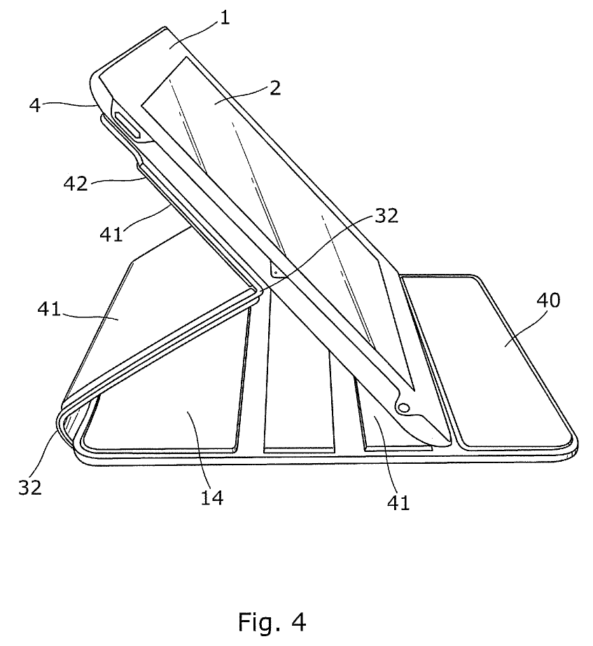

FIG. 4 shows a perspective side view of an alternative protective cover, on a tablet computing device, incorporating a planar fuel source for supplying fuel to a fuel cell embedded in the tablet computing device;

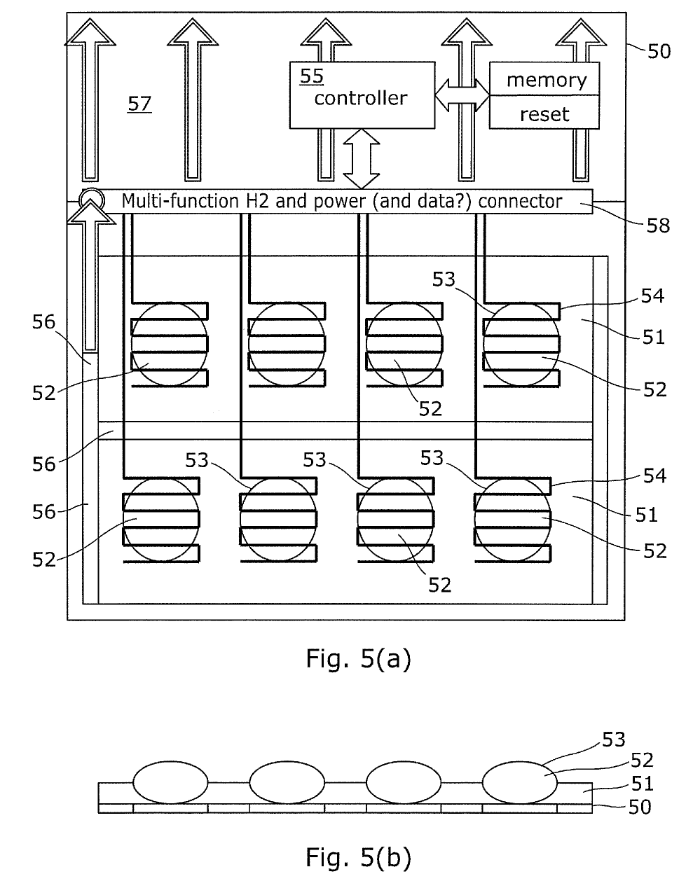

FIG. 5 shows (a) a schematic plan view and (b) a schematic side view of a protective cover for a tablet computing device showing an arrangement of electrically actuatable fuel sources and fluid conduits therefrom;

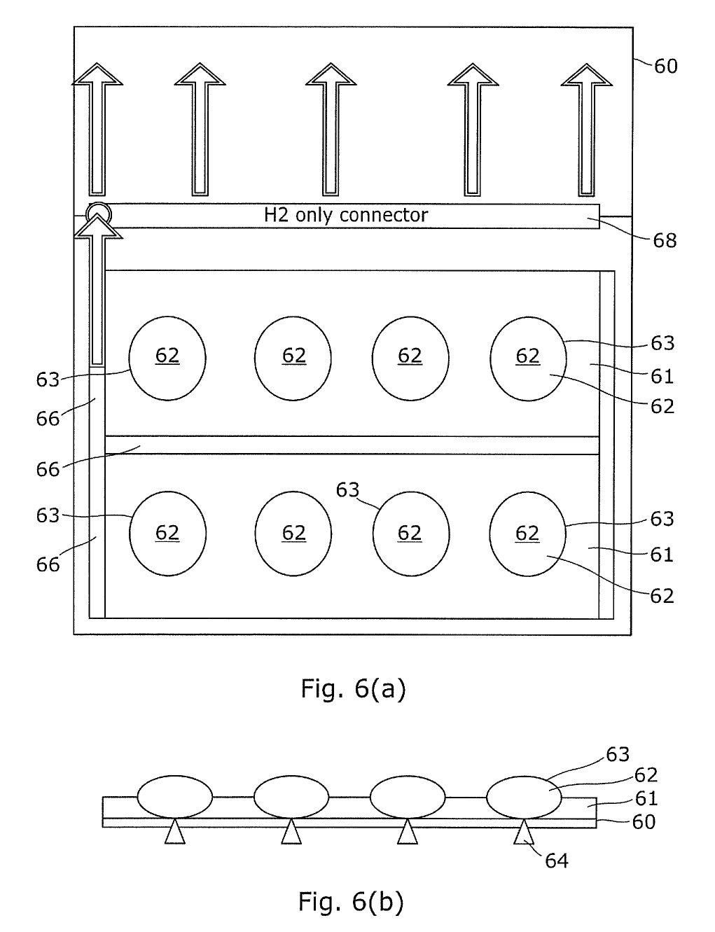

FIG. 6 shows (a) a schematic plan view and (b) a schematic side view of a protective cover for a tablet computing device showing an arrangement of mechanically actuatable fuel sources and fluid conduits therefrom;

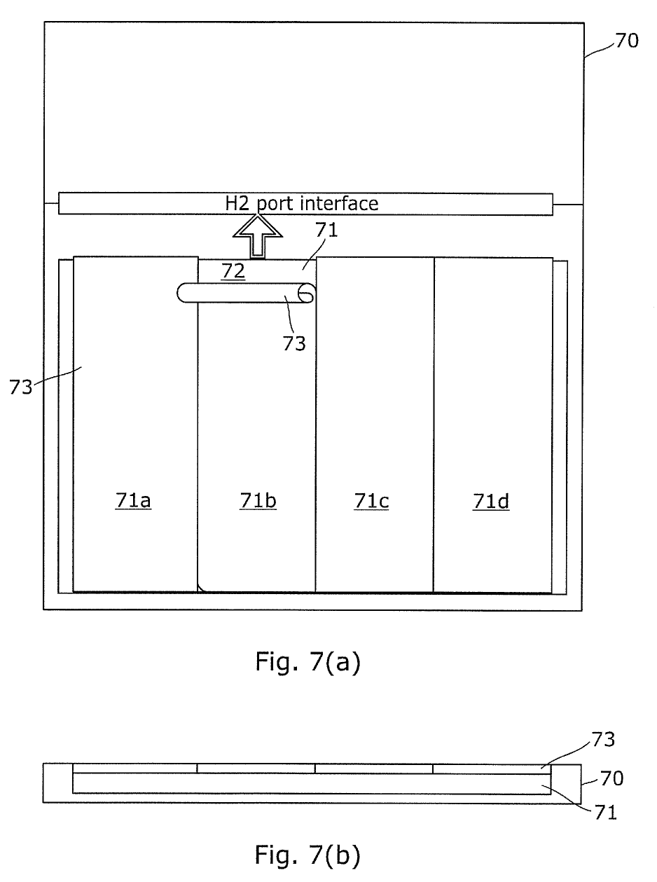

FIG. 7 shows (a) a schematic plan view and (b) a schematic side view of a protective cover for a tablet computing device showing an arrangement of mechanically actuatable fuel sources and fluid conduits therefrom.

Users of portable computing devices such as tablet computers, smart phones and laptop computers generally desire the devices to be as small and lightweight as practicable, and particularly for the devices to be as thin as possible. However, it is common practice for users to wish to protect their devices from general impact and abrasion damage such as from knocks and scratches, by use of a protective cover. The protective cover may be supplied by the manufacturer of the portable computing device or sold as an after-market accessory by a third party.

Some possible features of protective covers include (i) that they have a measure of shock absorbency and/or abrasion resistance; (ii) they do not necessarily need to be coupled to the portable computing device all the time, e.g. they can be detached and the portable device used independently of the protective cover when the protection is not required; (iii) they can be readily replaced; (iv) they may be designed to serve as a stand for the device when in use; (v) users are generally more accepting of an increase in size and weight of the device attributable to the protective cover which they would find less desirable if built in to the device itself, possibly in view of at least item (ii) above.

The inventors have recognised that at least some of these attributes are compatible with, and find synergy with, the provision of a fuel cell-based power source for intermittently powering the portable computing device, or for periodically charging the portable computing device.

A fluid fuel source for an electrochemical fuel cell generally requires routine replacement or replenishment. It does not need to be coupled to the portable computing device all the time; in fact its use may be most often required when the device is not in use in a home/office environment and the use of a protective cover for the device is desirable. Some fluid fuel sources for generating hydrogen on demand may include fluid chambers or pouches filled with a paste or a gel and therefore provide the possibility of some shock absorbing capacity. Further, elements of a fluid fuel source may need replacement and/or replenishment more frequently than serviceable items in a portable computing device.

Thus, there is an opportunity to beneficially combine some attributes of a protective cover for a portable computing device with a fuel source for providing fluid fuel to an electrochemical fuel cell that can electrically power the device, e.g. when battery or mains electrical power are not available.

FIG. 1 shows a tablet computing device 1 with a protective cover 10 extendable over at least a display face 2 of the tablet. The protective cover 10 may comprise a set of planar panels 11 which may be separated by hinge regions 12 allowing the planar panels 11 to be rotatable relative to one another. The protective cover 10 may be coupled to the tablet 1 by way of a hinged coupling 13.

One or more of the planar panels 11 may incorporate a generally planar fluid fuel source 14 disposed within a compartment within the panel 11. In the arrangement shown in FIG. 1, for example, three out of four of the panels 11 comprise a fluid fuel source 14. A fourth panel incorporates a planar electrochemical fuel cell 15 configured to generate electrical power using fluid fuel provided by the fuel sources 14. The hinged coupling 13 includes an electrical connector suitable for transferring electrical power generated by the fuel cell 15 to the tablet 1.

FIG. 2 shows a tablet computing device 1 with a protective cover 20 similar to that described in connection with FIG. 1. However, in this arrangement, the planar panels 11 each include a generally planar fluid fuel source 14 disposed within a compartment within the panel. An electrochemical fuel cell is incorporated into the body of the tablet 1 and the hinged coupling 23 includes a fluid fuel connector suitable for transferring fluid fuel, such as hydrogen, generated in and/or released by the fuel sources 14, to the fuel cell in the tablet body.

The protective cover 10 or 20 may be configured to operate as a stand for the tablet 1 as shown in FIG. 3. When the tablet is in use and the display face 2 is exposed to the user, the panels 11 of the protective cover 10 or 20 may be folded relative to one another and repositioned behind the tablet in the “stand” configuration 30 shown in FIG. 3, by virtue of the hinged coupling 23.

In the arrangement of FIG. 3, the positioning of a fuel cell 31 integrated into the tablet 1 is shown schematically. In this arrangement, and when the protective cover is in the “stand” configuration, the fuel cell 31 is in an elevated position relative to the fuel sources 14 and this may encourage efficient distribution of hydrogen from the fuel sources 14 to the fuel cell 31 and a tendency for contaminant gases in the fuel supply line to be displaced downwards by the hydrogen.

FIG. 4 shows a slightly modified arrangement of protective cover 40 which has three panels 41 capable of enveloping both major faces of the tablet, i.e. display face 2 and rear face 4. Fuel sources 14 may be disposed within compartments of one or more of the three panels 41, and hinge regions 32 may include fluid fuel conduits for passing fluid fuel between the panels and to a fuel cell which may be located in the tablet 1 or in one of the panels 41. Similar to the arrangement of FIG. 3, the fuel sources in one or more of the panels 41 may be positioned, when the protective cover 40 is in use in a “stand” configuration as shown, below the level of a fuel cell disposed in the tablet 1 or in an upper panel 42 of the protective cover 40, thereby assisting efficient distribution of hydrogen.

The fuel sources located within compartments in the protective covers 10, 20, 30, 40 may be of various types. One convenient fuel source arrangement comprises a reaction chamber filled with a suitable first reactant such as sodium borohydride and a reservoir of a suitable second reactant, such as water. When hydrogen is required, water can be released from the reservoir into the reaction chamber to initiate a hydrolysis reaction in which hydrogen is released (e.g. NaBH₄+2 H₂O→NaBO₂+4 H₂).

FIG. 5 shows an arrangement of fuel sources within a protective cover 50 for a portable computing device, such as the protective covers described in connection with FIGS. 1 to 4. One or more reaction chambers 51 are filled with a suitable first reactant, such as described above, and reservoirs 52 of a suitable second reactant are provided adjacent to the reaction chambers 51. In one arrangement, each of the reservoirs 52 may be a fluid-filled, rupturable container 53 such as a blister or bladder arrangement, disposed within or fluidly coupled to a reaction chamber 51. Preferably, each of the containers 53 can be independently ruptured so as to enable a series of limited releases of the second reactant into the respective reaction chamber 51, thereby enabling a limited and controllable level of hydrogen production.

Each reaction chamber 51 may have plural reservoirs 52 associated with it, and may be disposed within a separate planar panel 11 of the protective cover 50.

In the example of FIG. 5, each of the containers 53 providing a reservoir 52 of second reactant may be ruptured electrically by passing a current through a respective heating element 54. The individual heating elements 54 may be controlled by a controller 55. The controller 55 may be configured to monitor hydrogen pressure and/or hydrogen flow rate through fuel conduits 56 from which the fluid fuel is delivered to a fuel cell 57 located either in the protective cover 10, 20, 30, 40, 50 (as depicted schematically in FIG. 5) or within a portable computing device 1 to which the protective cover is attached. The controller 55 may be coupled to the fuel cell in order to determine fuel demand. A multi-function fluid fuel, power and data connector 58 may be provided between the fuel sources 51 and the controller 55 and fuel cell 57 and/or portable computing device 1. Techniques for containment and selective release of an activation fluid such as the second reactant are further described in international patent application PCT/GB2014/051360.

The fuel sources comprising reaction chambers 51 and reservoirs 52 in bladders 53 may be integrated into compartments within the cover 50 or may be removably inserted into pouches, sleeves or other types of chambers within the cover 50, such that they are replaceable. In the latter configuration, the connector 58 may provide a convenient interface for replaceable fuel sources. In the former configuration, the protective cover 50 or parts thereof could be made a disposable item when the fuel supply is exhausted. The controller 55 may be provided with a memory and/or reset function 59. The memory could be used to maintain information relating to a current state of the fuel sources 51, 52, 53 and which could be resettable in the situation that the fuel sources are replaceable/refillable, e.g. by insertion into pouches in the protective cover 50.

The arrangement of FIG. 5 exemplifies a protective cover in which the fuel sources are independently electrically actuatable. FIG. 6 illustrates an alternative arrangement in which the fuel sources are mechanically actuatable.

FIG. 6 shows an arrangement of fuel sources within a protective cover 60 similar to FIG. 5. One or more reaction chambers 61 are filled with a suitable first reactant, such as described above, and reservoirs 62 of a suitable second reactant are provided adjacent to the reaction chambers 61. Each of the reservoirs 62 may be a fluid-filled, rupturable container 63 such as a blister or bladder arrangement, disposed within or fluidly coupled to a reaction chamber 61. Similar to FIG. 5, each of the containers 63 can be independently ruptured so as to enable a series of limited releases of the second reactant into the respective reaction chamber 61, thereby enabling a limited and controllable level of hydrogen production. However, in this example, the rupture of each container 63 may be by mechanical damage to the container by the user purposefully squashing the container against a rupture element 64 such as a rupture pin. Alternatively, each container 63 could be provided with a region of weakness configured to preferentially rupture under stress.

Other features of the arrangement of FIG. 6 may be similar to those of FIG. 5, such as fuel conduits 66 by which fluid fuel is delivered from the reaction chambers 61 to a connector 68. In view of the mechanical actuation of the fuel sources, the multi-function fluid fuel, power and data connector 58 of FIG. 5 could be simplified with a fluid fuel connector 68 which does not necessarily require an electrical/data interface.

FIG. 7 shows another arrangement of fuel sources within a protective cover 70 in which fuel sources are also mechanically actuatable. One or more reaction chambers 71 are filled with a suitable first reactant. The reaction chambers 71 have at least one surface portion 72 which comprises a membrane through which moisture from the atmosphere can permeate, the moisture acting as a second reactant, e.g. for a vapour hydrolysis reaction. The membrane is configured to be permeable to moisture but not to the fuel produced by the reaction. Nafion may be used as the membrane, which is substantially impermeable to hydrogen but allows moisture to pass through it. The surface portion 72 is initially protected by an impermeable sheet 73, which is shown in place for reaction chambers 71a, 71c, 71d, to prevent the reaction commencing until required by the user. The impermeable sheet 73 may be selectively peeled away, at least in part, or entirely, for each reaction chamber, as particularly shown for reaction chamber 71b. Therefore, similar to the arrangements of FIGS. 5 and 6, each of the reaction chambers 71a . . . 71d can be independently activated by peeling back a membrane cover so as to enable a series of releases of the second reactant (from the atmosphere) into the respective reaction chamber 71, thereby enabling a limited and controllable level of hydrogen or other fuel production.

Similar arrangements using tear-off strips or mechanical removal of other barriers between a first and second reactant can be used. For example, sliding windows (linear or rotary) could be selectively moved to expose and then cover again reaction chambers or parts of reaction chambers.

Other features of the arrangement of FIG. 7 may be similar to those of FIGS. 5 and 6.

In each case, the separate reaction chambers may be isolated from one another and from the fuel conduits by valve arrangements, such as a one-way valve preventing hydrogen from passing into previously exhausted reaction chambers, and/or barriers such as gauzes preventing egress of reactant by-product from reaction chambers into the fuel conduits 56, 66.

In the arrangements shown in FIGS. 5 and 6, eight separate reaction chamber/reservoir pairs are shown, suggesting eight separate activations and releases of hydrogen could be initiated. Any practicable number of separate fuel sources/reaction chambers/reservoirs could be deployed. It may be beneficial for actuation of the individual fuel sources to be effected starting from the source that is remotest from the connector to the fuel cell, e.g. connector 58, 68.

The protective covers as described above generally house a fuel source within a compartment in the cover, and exemplary arrangements use a reaction chamber with a first reactant and a reservoir with a second reactant within the compartment, to enable an on-demand hydrolysis reaction. However, other chemistries can be considered, including arrangements for a thermolysis reaction to generate the fuel, or a desorption process to generate the fuel. The number of chambers required for each process, in a compartment of the protective cover, may vary.

Generally, multiple compartments in the protective cover can house separately actuatable fuel sources. Actuation may encompass any physical, mechanical, electrical or chemical procedure by which generation, and/or release of fuel from the fuel source may be initiated.

Provision of thin fuel sources within generally planar compartments of a protective cover may offer further benefits over more conventional fuel sources which may take the form of cuboid or cylindrical cartridges in that the surface area available for heat dissipation or heat transfer to ambient is increased. Thus the fuel generating reaction, whether it is endothermic or exothermic, will create lower levels of localised temperature changes. This may assist in avoiding overheating of the protective cover and/or the portable computing device, for example.

In some arrangements, it may be possible to provide two or more separately actuatable fuel sources overlaying one another within compartments of the protective cover. Thus, an array of fuel sources within one or more compartments of the protective cover as described above may have a further stacked array overlying the first array, within volumes defined by the panels of the cover.

Although the illustrative embodiments of FIGS. 1 to 7 show the fuel sources integrated into a protective cover for a tablet-type portable computing device, the same principles can be applied in the formation of a protective cover for any other type of portable computing device, such as lap-tops, netbooks, palm computers, personal organisers, ‘smart phones’ etc. The protective cover could take the form of a half-case for a smart phone, for example, in which the case covers the back of the phone and wraps around at least some of the sides. The half-case may have a lip wrapping around the peripheral edge of the front face of the phone to retain it in place. The half-case could take the form of an anti-skid case generally used to protect the back of the phone and the side edges of the phone with a high friction elastomeric material or similar. Such cases provide protection for the phone and prevent it sliding off surfaces, e.g. when in moving vehicles. The protective cover could include an integrated power plug on an inside face for engaging with the data and/or power connector of the phone, e.g. its USB connector socket.

For many portable computing devices, the protective cover may be configured as a plurality of planar panels separated by one or more hinge regions. Each planar panel can therefore serve to protect at least a part of one face of the device, and hinge regions enable the protective cover to be wrapped around the device and/or folded to provide other structures such as stands, as exemplified above. Thus, in a general aspect, the folding protective cover as described above exemplifies a protective cover which is moveable between a first configuration for at least partially enclosing the portable computing device and a second configuration configured to operate as a stand for the portable computing device. Each planar panel can also serve as one of a fuel source compartment and a fuel cell compartment.

The protective cover preferably comprises a user-detachable cover that is separate from the housing of the portable computing device which it protects. The protective cover may have a detachable fluid coupling for conveying fluid fuel from fuel sources within the protective cover to a fuel cell disposed within the portable computing device, such as exemplified by the hinged coupling 23 in FIG. 2. The protective cover is preferably configured to encompass at least one face of the portable computing device as exemplified in FIGS. 1 and 2, or at least three faces (e.g. two faces and an edge) as exemplified in FIG. 4, or at least four faces (e.g. two faces and two edges), or all six faces of a generally cuboid device. Other combinations are possible.

The protective cover may include a control mechanism by which activation of fuel sources and/or fuel cells within the protective cover is enabled by the opening of at least one panel of the protective cover, e.g. when the portable computing device is in use.

The arrangement of FIG. 2 illustrates a further principle embodied in this disclosure in which a planar fuel cell 15 and a planar fuel source 14 may be mounted together in co-planar relationship on a common substrate. The substrate may comprise the panels 11 of the protective cover. In some arrangements the common substrate may include hinged sections such as exemplified by hinge regions 12, thereby enabling the planar fuel cell and the planar fuel source to be coplanar with one another in at least one configuration, and to rotate relative to one another in another configuration. In such an arrangement, a flexible fluid conduit may be provided which traverses the hinge regions to enable fuel flow from the fuel source to the fuel cell across the hinge region.

In this context, the planar fuel cell may be a fuel cell assembly not forming part of a conventional “stack” with multiple cells arranged in series relationship one on top of another, but a fuel cell assembly having one or more cells all occupying the same plane.

Other embodiments are intentionally within the scope of the accompanying claims.

1. A protective cover for a portable computing device, comprising:
a fuel source disposed in a compartment within the protective cover.

2. The protective cover of claim 1 comprising a plurality of separate compartments each providing a separately actuatable fuel source.

3. The protective cover of claim 2 comprising a controller configured to actuate release of fuel from each compartment independently.

4. The protective cover of claim 3 wherein each compartment is configured to be ruptured electrically by passing a current through a respective heating element, wherein the individual heating elements are controlled by the controller.

5. The protective cover of claim 2 comprising a plurality of substantially planar fuel sources provided within respective planar panels that are separated by one or more hinge regions.

6. The protective cover of claim 2 comprising a plurality of planar panels separated by a one or more hinge regions.

7. The protective cover of claim 1 in which the fuel source compartment is substantially planar.

8. The protective cover of claim 1 in which the fuel source is a hydrogen fuel source.

9. The protective cover of claim 8 wherein the hydrogen fuel source is configured to generate gaseous hydrogen by at least one of a hydrolysis reaction, and a thermolysis reaction; a desorption process.

10. The protective cover of claim 8 further including a hydrogen fluid line and hydrogen port for coupling the cover to a fuel consuming device.

11. The protective cover of claim 10 in which the cover is moveable between a first configuration for at least partially enclosing the portable computing device and a second configuration configured to operate as a stand for the portable computing device, and in which the port for coupling the fluid line to the fuel consuming device is positioned in a lower portion of the cover when in the second configuration.

12. The protective cover of claim 10 comprising a combined hydrogen port and electrical connector for coupling to a portable computing device within the protective cover.

13. The protective cover of claim 1 further including a fuel cell disposed within the protective cover.

14. The protective cover of claim 1 in which the fuel source compartment comprises a replaceable element receivable into a pouch in the protective cover.

15. A power generating apparatus comprising a planar fuel cell; and, a planar fuel source mounted together in co-planar relationship on a common substrate.

16. The apparatus of claim 15 in which the fuel source comprises a plurality of separate compartments each providing a separately actuatable reaction chamber.

17. The protective cover of claim 16 comprising a controller configured to actuate release of fuel from each reaction chamber independently.

18. The protective cover of claim 16 wherein each compartment is configured to be ruptured electrically by passing a current through a respective heating element, wherein the individual heating elements are controlled by the controller.

19. The apparatus of any of claim 15 comprising a plurality of panels separated by one or more hinge regions.

20. The apparatus of claim 19 further comprising a fluid flow conduit extending across said one or more hinge regions.

21. The apparatus of claim 15 in which the fuel source is a hydrogen fuel source.

22. The apparatus of claim 21 in which the hydrogen fuel source is configured to generate gaseous hydrogen by one of: a hydrolysis reaction; a thermolysis reaction; a desorption process.

23. A method of providing protection to, and power for, a portable computing device, comprising at least partially encasing a portable computing device with a protective cover having a fuel source disposed in a compartment within the protective cover.

24. The method of claim 23 further comprising generating fluid fuel from the fuel source and providing the fluid fuel to a fuel cell.

25. The method of claim 23 further comprising providing a plurality of separate compartments each providing a separately actuatable fuel source, and actuating release of fuel from each compartment independently.

26. The method of claim 23 further including connecting a fluid line from the cover to a fuel consuming device in the portable computing device.

27. The method of claim 23 further including moving the cover between a first configuration for at least partially enclosing the portable computing device and a second configuration configured to operate as a stand for the portable computing device.

28. The method of claim 23 further including providing a fuel cell within the protective cover and using the generated fluid fuel to generate electrical power within the fuel cell.

29. The method of claim 23 further including replacing a fuel source within a compartment in the protective cover.
